(19) United States
(12) Patent Application Publication
(10) Pub. No.: US 2008/0246729 A1
(43) Pub. Date: Oct. 9, 2008

(54) CASING OF MOUSE

(75) Inventor: Chou-Hang YANG, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/062,070

(22) Filed: Apr. 3, 2008

(30) Foreign Application Priority Data
Apr. 4, 2007 (TW) 096111961

(51) Int. Cl. G06F 3/033

(52) U.S. Cl. 345/163

(57) ABSTRACT

The present invention provides a casing of a mouse. The casing includes a base, a first step, and a second step. In particular, the casing according to the invention enables users to conveniently hold, and is not easily to fall while lifting.

### BACKGROUND OF THE INVENTION

1. Field of the Invention

This invention relates to a casing of a mouse, and more particularly, the invention relates to a casing of a mouse enabling a user to conveniently hold and lift the mouse without dropping it. The ergonomics design of the casing of the invention can help the user to operate the mouse in comfort.

2. Description of the Prior Art

Nowadays, mouse has become one of the important input devices of the personal computer. The word “mouse” also means that it can be as nimble as a rat. The mouse can replace fingers to carry out many clicking works required by computer operations. Besides, the displacement sensing module of the mouse from the mechanical type goes through the optomechanical type and the optoelectronic type, and even to the wireless communication type for communicating with computer.

At the same time, the precise positioning and specific appearances of the mouse are developed quickly, so that the mouse has become an important device for computer equipments. Therefore, the operation time of mouse is longer than before. Most of the mice possess functions of controlling cursor and clicking, and the differences between the mice in the market are the design of appearances.

The general mechanic mouse utilizes the motion of the ball of the disc encoder to calculate the sliding distance and direction of the cursor on the screen; the optical mouse utilizes the red light LED to emit light to a plate and receives returned images in a regular time to determine the moving distance of the mouse. In other words, the used cursor control way of the mouse is moving the mouse to the direction required by the user, and the cursor could be controlled by the detection of the moving sensing module.

However, the appearance design of the mouse is largely related to the comfortableness of operation, therefore, it is very important whether the appearance of the mouse fits to ergonomics. Please refer to FIG. 1A and FIG. 1B. FIG. 1A illustrates a section diagram of a thumb 20 and a ring finger 22 hold the casing 1 of a traditional mouse. FIG. 1B illustrates a section diagram of a thumb 40 and a ring finger 42 hold the casing 3 of another traditional mouse. As shown in FIG. 1A, most of the traditional mice have inverse ladder-shaped cross-section of the casing 1 for preventing the mouse, held by the user, from falling. However, this design of the mouse does not fit the angle of the thumb 20 and the ring finger 22 put on the mouse. As shown in FIG. 1B, another type of tradition mice has ladder-shaped cross-section of casing 3. Although this design of the mouse fits the angle of the thumb 40 and the ring finger 42 put on the mouse, it results in the shortcomings that the mouse is easily to fall while lifting.

### SUMMARY OF THE INVENTION

Therefore, a scope of the invention is to provide a casing of a mouse, wherein the casing comprises a first step and a second step. According to the first step and the second step configured on the casing of the mouse, the user can hold and lift the mouse easily and comfortably.

The casing of the mouse according to a preferred embodiment of the invention comprises a base, a first step, and a second step. The base thereon defines a longitudinal direction, and the base has a first side and a second side opposite to the first side. The first step is substantially formed along the longitudinal direction on the surface of the first side. The second step is substantially formed along the longitudinal direction on the surface of the second side.

The casing of the mouse according to another preferred embodiment of the invention comprises a base, a first step, and a second step. The base thereon defines a normal direction, and the base has a first side and a second side opposite to the first side. The first side is divided into a first upper portion and a first lower portion tilting to the normal direction. The second side is divided into a second upper portion and a second lower portion tilting to the normal direction. The first step is formed between the first upper portion and the first lower portion. The second step is formed between the second upper portion and the second lower portion.

Accordingly, the first step and the second step of the casing of the invention can help user to easily and comfortably hold and lift the mouse.

The advantage and spirit of the invention may be understood by the following recitations together with the appended drawings.

### BRIEF DESCRIPTION OF THE APPENDED DRAWINGS

FIG. 1A illustrates a section diagram of a thumb and a ring finger holding the casing of a traditional mouse.

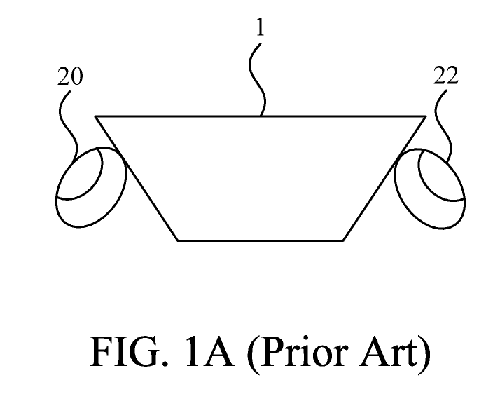

FIG. 1B illustrates a section diagram of a thumb and a ring finger holding the casing of another traditional mouse.

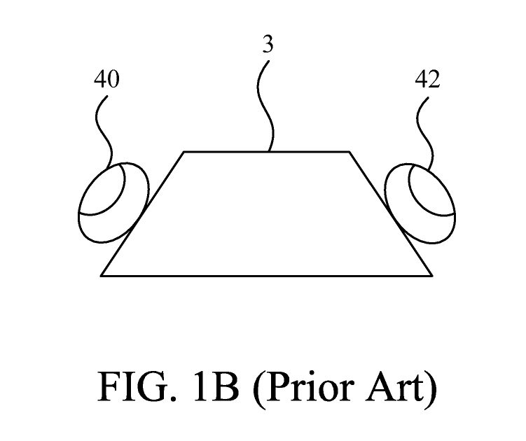

FIG. 2A illustrates a front view of a casing of a mouse according to a preferred embodiment of the invention.

FIG. 2B is a side view of the casing in FIG. 2A.

FIG. 2C shows another side of the casing in FIG. 2A.

FIG. 3A illustrates a front view of the casing of the mouse according to another preferred embodiment of the invention.

FIG. 3B is a side view of the casing in FIG. 3A.

FIG. 3C shows another side of the casing in FIG. 3C

### DETAILED DESCRIPTION OF THE INVENTION

The scope of the invention is to provide a casing of a mouse. The casing of the invention enables a user to conveniently hold and lift the mouse without dropping it. Furthermore, according to the design of ergonomics, the user can operate the mouse with the casing of the invention in comfort. Besides, the user can put his or her fingers on the casing without rubbing against the table when he or she controls the mouse. The characteristics, spirit, advantages, and conveniences of the invention would be described in the following preferred embodiments.

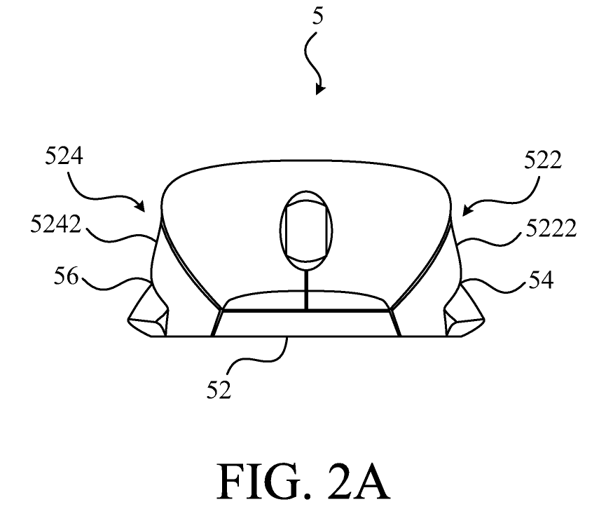

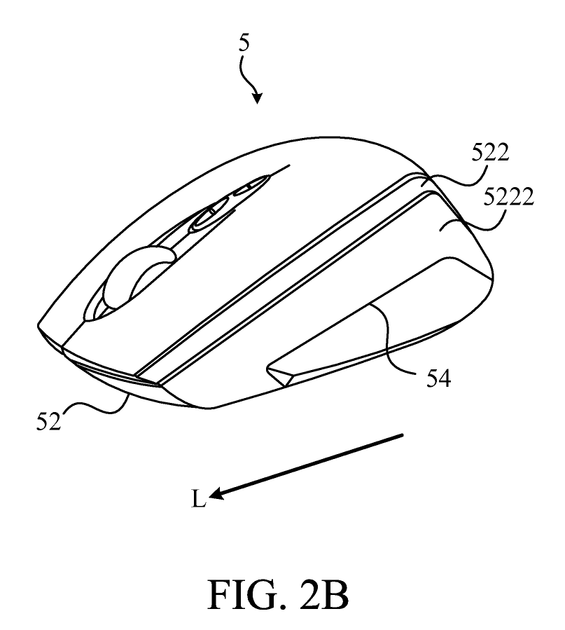

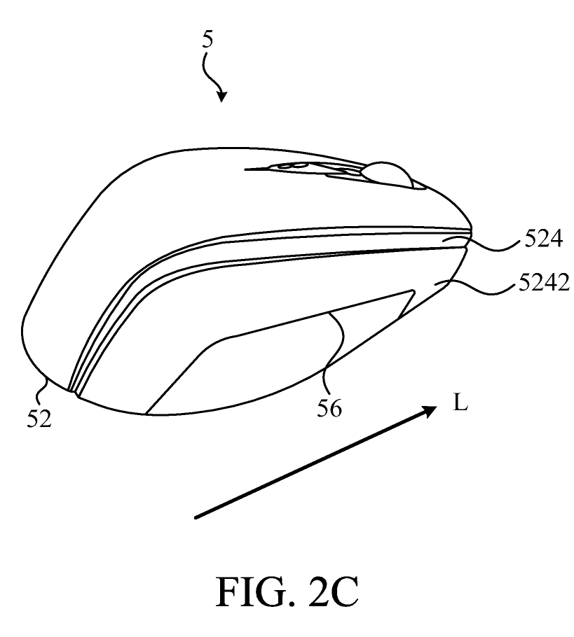

Please refer to FIGS. 2A, 2B, and 2C. FIG. 2A is a front view of a casing 5 of a mouse according to a preferred embodiment of the invention; FIG. 2B is a side view of the casing 5 in FIG. 2A; FIG. 2C shows another side of the casing 5 in FIG. 2A.

As shown in FIGS. 2A, 2B, and 2C, the casing 5 comprises a base 52, a first step 54, and a second step 56. The base 52 thereon defines a longitudinal direction L, and the base 52 has a first side 522 and a second side 524 opposite to the first side 522. The first step 54 is substantially formed along the longitudinal direction L on the surface of the first side 522. The second step 56 is substantially formed along the longitudinal direction L on the surface of the second side 524.

To prevent fingers of a user from contacting with the table when the user controls the mouse, the portion of the first side 522 below the lower edge of the first step 54 tilts outwardly and the portion of the second side 524 below the lower edge of the second step 56 tilts outwardly in an embodiment. Therefore, the user can put his or her fingers on the casing 5 to operate the mouse without rubbing the table.

Furthermore, to let the user easily control the mouse, the casing of the invention further comprises a first skid-proof part 5222 and a second skid-proof part 5242 in an embodiment. The first skid-proof part 5222 is attached to the upper edge of the first step 54, and the second skid-proof part 5242 is attached to the upper edge of the second step 56. Accordingly, the frictional force provided by the first skid-proof part 5222 and the second skid-proof part 5242 can let the user easily control but not easily drop the mouse while lifting it.

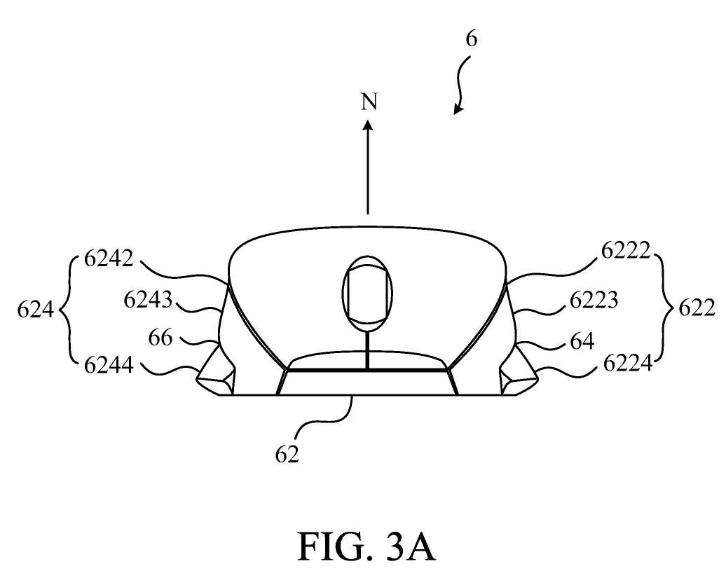

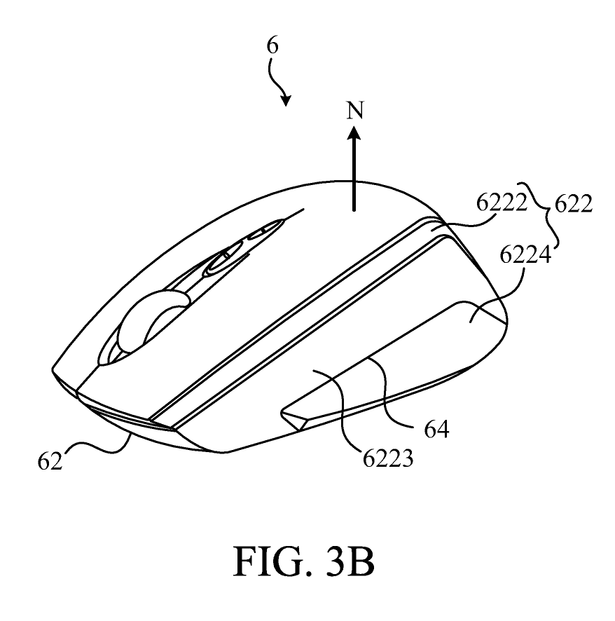

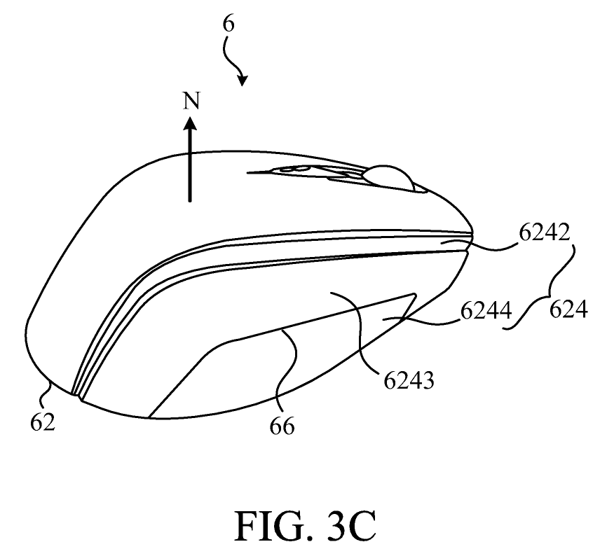

Pleas refer to FIG. 3A, FIG. 3B, and FIG. 3C. FIG. 3A is a front view of the casing 6 of a mouse according to another preferred embodiment of the invention; FIG. 3B is a side view of the casing 6 in FIG. 3A; FIG. 3C is another side view of the casing 6 in FIG. 3C.

As shown in FIG. 3A, FIG. 3B, and FIG. 3C, the casing 6 comprises a base 62, a first step 64 and a second step 66. The base 62 thereon defines a normal direction N, and the base has a first side 622 and a second side 624 opposite to the first side 622. The first side 622 is divided into a first upper portion 6222 and a first lower portion 6224 tilting to the normal direction N. The second side 624 is divided into a second upper portion 6242 and a second lower portion 6244 tilting to the normal direction N. The first step 64 is formed between the first upper portion 6222 and the first lower portion 6242. The second step 66 is formed between the second upper portion 6242 and the second lower portion 6244.

In an embodiment, the first upper portion 6222 and the second upper portion 6242 are substantially parallel to the normal direction N.

To prevent fingers of a user from contacting with the table when the user controls the mouse, the first lower portion 6224 tilts outwardly and the second lower portion 6244 tilts outwardly in an embodiment. Therefore, the user can put his or her fingers on the casing 6 to operate the mouse without rubbing the table.

Furthermore, to let the user easily control the mouse, the casing 6 of the invention further comprises a first skid-proof part 6223 and a second skid-proof part 6243 in an embodiment. The first skid-proof part 6223 is attached to the upper edge of the first step 64, and the second skid-proof part 6243 is attached to the upper edge of the second step 66. Accordingly, the frictional force provided by the first skid-proof part 6223 and the second skid-proof 6243 can let the user easily control but not easily drop the mouse while lifting it.

In an embodiment, the first skid-proof parts 5222, 6223 and the second skid-proof parts 5242, 6243 could be formed of rubber, resin, or polymer.

Compared to the prior art, the user can easily and comfortably hold and lift the mouse with the first step and the second step configured on the casing of the mouse of the invention. Besides, the user can put his or her fingers on the casing of the invention to operate the mouse without rubbing the table.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A casing of a mouse, comprising:
a base, thereon defining a longitudinal direction, and the base having a first side and a second side opposite to the first side;
a first step, substantially formed along the longitudinal direction on the surface of the first side; and
a second step, substantially formed along the longitudinal direction on the surface of the second side.

2. The casing of claim 1, further comprising:
a first skid-proof part, attached to the upper edge of the first step; and
a second skid-proof part, attached to the upper edge of the second step.

3. The casing of claim 2, wherein the first skid-proof part and the second skid-proof part are formed of one selected from a group consisting of a rubber, a resin, and a polymer.

4. The casing of claim 1, wherein the portion of the first side below the lower edge of the first step tilts outwardly, and the portion of the second side below the lower edge of the second step tilts outwardly.

5. A casing of a mouse, comprising:
a base, thereon defining a normal direction, and the base having a first side and a second side opposite to the first side, the first side being divided into a first upper portion and a first lower portion tilting to the normal direction, the second side being divided into a second upper portion and a second lower portion tilting to the normal direction;
a first step, formed between the first upper portion and the first lower portion; and
a second step, formed between the second upper portion and the second lower portion.

6. The casing of claim 5, further comprising:
a first skid-proof part, attached to the upper edge of the first step; and
a second skid-proof part, attached to the upper edge of the second step.

7. The casing of claim 6, wherein the first skid-proof part and the second skid-proof part are formed of one selected from a group consisting of a rubber, a resin, and a polymer.

8. The casing of claim 5, wherein the first upper portion and the second upper portion are substantially parallel to the normal direction.

9. The casing of claim 6, wherein the first lower portion tilts outwardly, and the second lower portion tilts outwardly.
